(19) United States
(12) Patent Application Publication
(10) Pub. No.: US 2002/0110719 A1
(43) Pub. Date: Aug. 15, 2002

(54) Multipart separator plate for an electrochemical cell

(76) Inventors: Shyhing M Pien, Acton, MA (US); Steve Lis, Needham, MA (US); Bernard F. Taylor, Lynnfield, MA (US)

Correspondence Address: Iandiorio & Teska, 260 Bear Hill Road, Waltham, MA, 02451-1018, US

(21) Appl. No.: 09/779,972

(22) Filed: Feb. 9, 2001

(51) Int. Cl. H01M 8/04; H01M 2/08; H01M 8/02

(52) U.S. Cl. 429/35; 429/38; 429/26

(57) ABSTRACT

A multipart separator plate for an electrochemical cell includes a distributor plate interfacing with the membrane electrode assembly of an electrochemical cell; a frame surrounding the distributor plate; an impervious separator layer; and a seal layer between the separator layer and the distributor plate.

### RELATED APPLICATIONS

This invention was made with U.S. Government support under Contract No. DE-FC02-97EE50475 awarded by the Department of Energy. The Government may have certain rights in the subject invention.

### FIELD OF INVENTION

This invention relates to a multipart separator plate for an electrochemical cell such as a fuel cell or electrolyzer.

### BACKGROUND OF INVENTION

In conventional electrochemical cells such as fuel cells powered by hydrogen or hydrogen generated from a reformer supplied with methanol or other fuel, the separator plate is a monolithic part which serves a number of functions that require that it have a number of diverse properties. It must: support the fragile membrane electrode assembly; distribute reactant gases across both electrode surfaces; provide a low resistance, high current capacity electrical contact to the electrode; provide an impervious barrier to hydrogen, oxygen and water (effectively a vacuum seal); conduct electricity efficiently through its thickness; provide no contaminants to the electrodes despite the corrosive environment; remain stable over the life of the stack (10 to 30 years); permit waste heat removal; maintain full functionality over the temperature range of operation, which may be from −30 to +100 degrees C.

The conventional approach to separator plate design makes use of high purity graphite as the main constituent of the fuel cell stack. After 30 years, graphite has been found to be the only material that meets all of the above requirements simultaneously. The separator plate is a monolithic slab into which has been machined all the gas flow channels which permit the reactant gases to flow to the electrodes, and allows water and the remaining gases to flow away. The graphite succeeds in surviving the corrosive environment while remaining conductive, and high density forms of graphite (expensive) are available which provide a tight seal, yet maintain all the other attributes necessary for efficient fuel cell operation. Unfortunately, efficient stack operation requires that the bipolar plate be intricately machined, a process which adds to cost because it is such a hard material.

An additional method for making “monolithic” bipolar plates is to use a carbon composite material that incorporates a polymer binder. The binder is usually a polymer having a high chemical and thermal resistance such as Teflon®. This approach has the difficulty of resulting in a lower conductivity separator plate with increased electrical resistance, and therefore causes increased power losses.

The monolithic, hard, and flat plate permits designers to virtually ignore issues of thermal expansion and mechanical stability. Assembly is simple, because it is a single piece, and repeated re-assembly for research and development application is straightforward. But the problem with the present technology is cost. The penalty for taking the simple route is that it turns out to be very expensive. A very hard to produce and form material is selected (only machining with carbide tools permits success.) The gas-impervious forms of graphite are the most expensive and also most difficult to machine.

Alternative materials can individually respond to some of the requirements listed above. One of the best materials of modest cost is selected grades of stainless steel, but even these do not match the corrosion resistance of graphite. Common polymers can be used for structure, coatings, and sealants, but do not provide the electrical conductivity required.

Previous work has been reported of layered structure designs which use special bonding techniques or embossing and conductive adhesives to assemble the structure. Unfortunately, these approaches require the use of complex equipment, messy adhesives and difficult to control bonding processes. Furthermore, the resulting bipolar plate structure often has residual stresses than can cause the plate to be deformed or warp into a non-planar structure, making precision assembly more difficult. These stresses can also lead to debonding of the components which could lead to dangerous gas leaks or poor electrical contact and therefore high electrical resistance.

Electrolyzers suffer from the same problems and also use a monolithic separator plate but it is made of titanium which is also difficult to work and very expensive.

### SUMMARY OF THE INVENTION

It is therefore an object of this invention to provide an improved multipart separator plate.

It is a further object of this invention to provide such an improved multipart separator plate which is substantially lower in cost yet performs all the necessary functions.

It is a further object of this invention to provide such an improved multipart separator plate which is simple and easy to fabricate.

The invention results from the realization that a much less expensive yet fully functional separator plate for an electrochemical cell such as a fuel cell or electrolyzer can be made by building the separator plate not monolithically but as a number of separate parts each of which can be optimized as to its particular function to minimize cost while maintaining performance and integrity; thus the conventional single separator plate is instead, in accordance with this invention, formed from a number of parts including a distributor plate for directing fluid flow, a frame surrounding the distributor plate, an impervious separator layer, and a seal layer between the separator layer and distributor plate. The properties of the Grafoil are important for the design of the separator plate. Because the Grafoil can provide a sliding seal, the plate and therefore the stack can be assembled and varied in temperature with little or no internal stresses. This avoids warping of the parts and allows uniform electrical contact to be maintained despite the thermal expansion properties of the various components.

This invention features a multipart separator plate for a fuel cell including a distributor plate for directing fluid flow; a frame surrounding the distributor plate; an impervious separator layer; and a seal layer between the separator layer and the distributor plate.

In a preferred embodiment there may be an internal manifold in the frame and the separator layer and the seal layer for delivering fluid to and removing fluid from the distributor plate. The distributor plate may direct fluid flow to the membrane electrode assembly of the fuel cell. The internal manifold may deliver and remove fuel gas and oxidant gas to the distributor plate. The distributor plate may direct a coolant fluid flow and the internal manifold may deliver to and remove from the distributor plate a coolant fluid. The frame may be chemically stable in the presence of the fuel cell, fuel gas and oxidant gas. The frame may be thermally stable at fuel cell operating temperatures. The frame may include a polymer or a polycarbonate or a polyvinyl material. The frame may include a recess on its inner periphery for accommodating the periphery of the electrode of the membrane electrode assembly. The frame may include stops for directing the fluid flow in the distributor plate. The seal layer may be electrically conductive and it may be thermally and chemically stable. The seal layer may include a sheet of flexible graphite. The sealing layer may include Union Carbide Grafoil®. The fuel may include hydrogen, reformate, or methanol. The separator layer may include a metal and it may be stainless steel. The distributor plate may include porous graphite.

This invention also relates to a multipart separator plate for a fuel cell including a distributor plate for presenting a fuel gas to the membrane electrode assembly of a fuel cell. There is a frame surrounding the distributor plate and an impervious separator layer. The seal layer is located between the separator layer and the distributor plate.

In a preferred embodiment there may be an internal manifold in the frame, the separator layer and the seal layer for delivering fluid to and removing it from the distributor plate. The frame may be chemically stable in the presence of the fuel cell fuel gas and oxidant gas. The frame may be thermally stable at fuel cell operating temperatures. The frame may include a polymer, a polycarbonate, or a polyvinyl material. The frame may include a recess on its inner periphery for accommodating the periphery of the electrode of the membrane electrode assembly. The frame may include stops for directing the fluid flow in the distributor plate. The seal layer may be electrically conductive and may be thermally and chemically stable. The seal layer may include a sheet of flexible graphite or it may be Union Carbide Grafoil®. The fuel gas may include hydrogen, reformate, or methanol. The separator layer may include metal. The metal may be stainless steel. The distributor plate may include porous graphite.

The invention also relates to a multipart separator plate for an electolyzer including a distributor plate for presenting water to the membrane electrode assembly of the electrolyzer and a frame surrounding the distributor plate. There is also an impervious separator layer and a seal layer between the separator layer and the distributor plate.

### BRIEF DESCRIPTION OF THE DRAWINGS

Other objects, features and advantages will occur to those skilled in the art from the following description of a preferred embodiment and the accompanying drawings, in which:

FIG. 1 is an exploded three-dimensional schematic diagram of a fuel cell according to this invention;

FIG. 2 is an exploded three-dimensional view of the top distributor plate and frame of FIG. 1;

FIG. 3 is a view similar to FIG. 2 of the bottom distributor plate and frame of FIG. 1;

FIG. 4 is a top plan view of the distributor plate and frame of FIG. 3 showing the flow paths as a result of the stops formed on the frame;

FIG. 5 is a three-dimensional schematic diagram of an improved frame similar to that shown in FIGS. 1-4; and

FIG. 6 is a side sectional elevational schematic diagram of the membrane electrode assembly of FIG. 1.

### PREFERRED EMBODIMENT

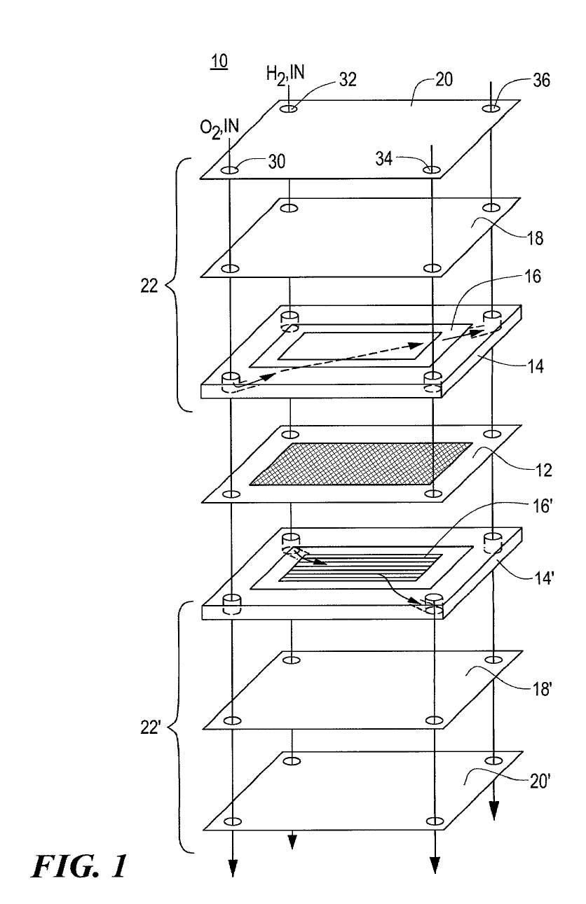

There is shown in FIG. 1 a fuel cell 10 according to this invention including a membrane electrode assembly 12, a top frame 14, and top distributor plate 16, the seal layer 18 and the separator layer 20. The lower half of fuel cell 10 includes identical parts given identical numbers accompanied by a prime.

Frame 14, distributor plate 16, seal layer 18, and separator 20 are referred to as the separator plate 22 and in prior art devices, all four of those parts were made in the single monolithic device. In fuel cells, the device was made of a single piece of graphite at great cost. For electrolyzers, it was made out of titanium, also a very expensive material, and both the titanium and the graphite are also expensive to work. By making the separator plate a multipart assembly, each part can be optimized as to its particular function and to minimize its costs while maintaining its performance and integrity so that all the functions of the conventional monolithic prior art separator plate are performed by these four parts. Frame 14, for example, may be made of a plastic such as a polycarbonate or polyvinyl so long as it is thermally stable at the operating temperature of the fuel cell or the electrolyzer and is chemically stable in the presence of fuel gas and oxidant gas in the case of a fuel cell or in the presence of water, hydrogen, and oxygen in the case of an electolyzer. The distributor plate may be made of any suitable material and no longer has to be impervious and in fact it can be made instead of a very inexpensive graphite; it can now be made of a cheap and inexpensive porous graphite in distributor plate 16. Seal layer 18 can be made of any suitable sealing material such as a sheet of flexible graphite such as Union Carbide GRAFOIL® and separator layer 20 may be made of any suitable impervious material typically metal such as stainless steel.

An internal manifold is created by passages 30, 32, 34, and 36 in the four comers of the separator layer 20, 20′, the seal layer 18, 18′, the frame 14, 14′ and the membrane electrode assembly 12. The manifold delivers hydrogen to one side of membrane electrode assembly 12, for example through passage 32, and removes it from the other side through passage 34 while delivering oxygen through passage 30 and removing it through passage 36. This same construction can be used to build an electrolyzer in which case water is supplied to the membrane electrode assembly 12 and hydrogen and oxygen are produced by it. It also should be noted that half of the fuel cell may be used in a stack of such fuel cells as a cooling component. In that case, an extra pair of passages is provided for the delivery and removal of the coolant such as antifreeze or water.

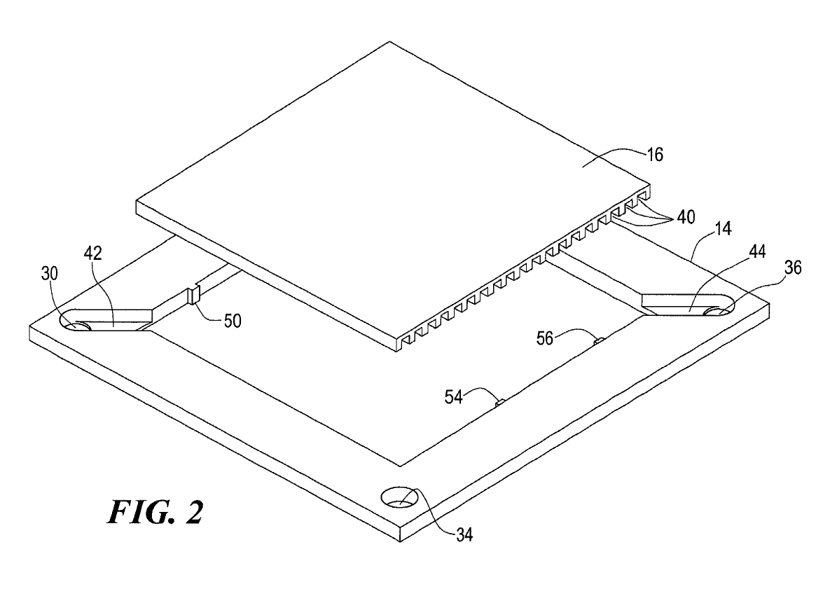

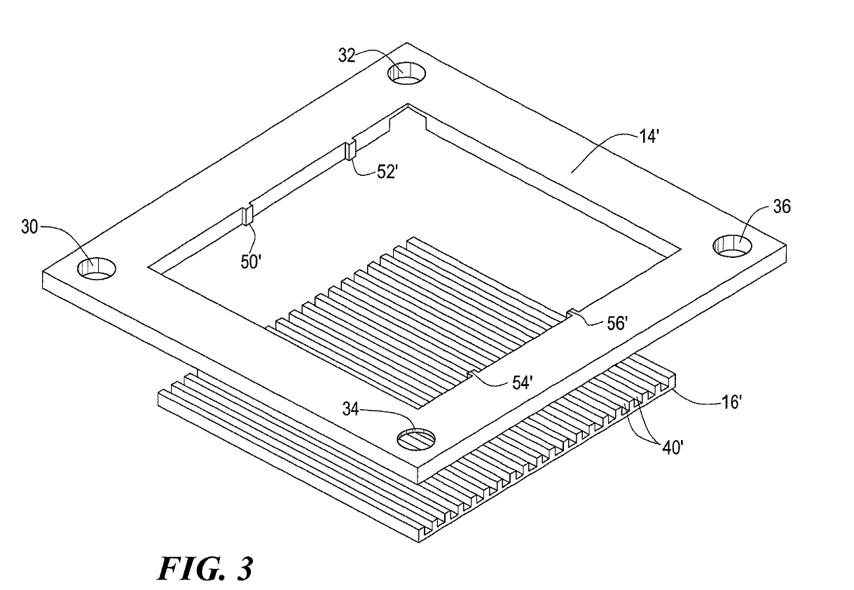

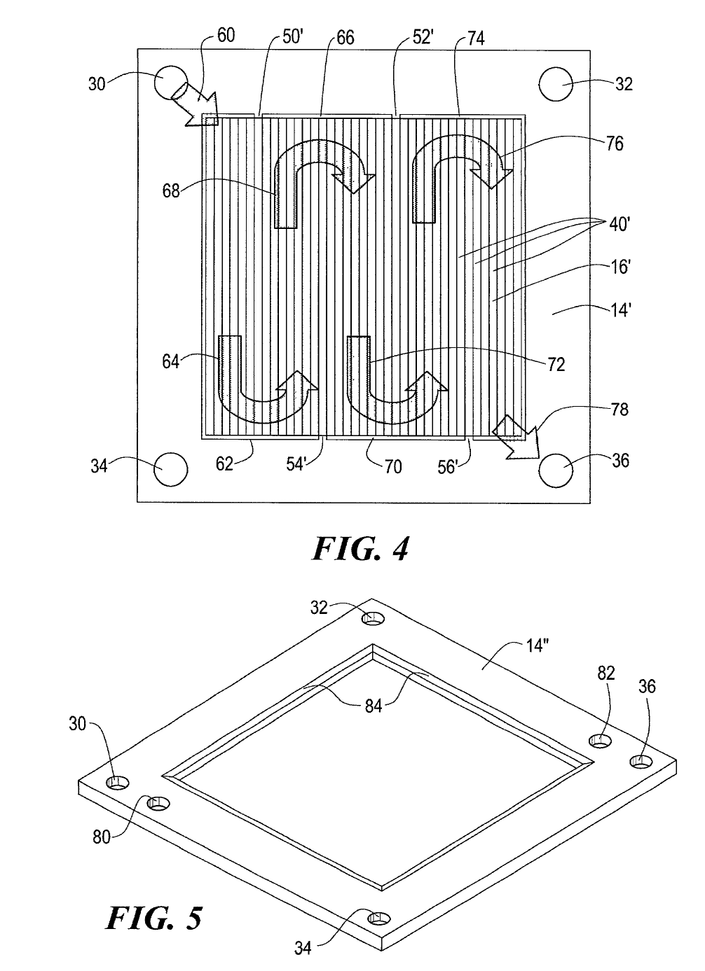

Upper frame 14 and distributor plate 16, are shown in greater detail in FIG. 2 where it can be seen that distributor plate 16, made for example of an inexpensive porous graphite, includes a plurality of channels 40 for delivering either hydrogen or oxygen to the membrane electrode assembly beneath it. Plenums 42 and 44 communicate between passages 30 and 36, respectively, and the channels 40 of distributor plate 16. Frame 14 may be provided with stops 50, 52 (not shown in FIG. 2), 54 and 56 to guide the flow of fluid through channels 40 and distributor plate 16. Frame 14′, FIG. 3, is provided with similar stops 50′, 52′, 54′, and 56′. The manner in which they control the flow can be better seen in FIG. 4. There, gas entering from passage 30, as indicated by arrow 60, moves along channels 40′ and around the ends of the channels in plenum 62 blocked by stop 54 and following the path as indicated by arrow 64. At the other end, the fluid moves through plenum 66 and, confronted by stop 52′ returns back in the direction as indicated by arrow 68. Responding to the stop 56′ and utilizing plenum 70 the fluid turns again as indicated by arrow 72 and returns to the other end where using plenum 74 it again turns as indicated by arrow 76 coursing through channels 40′ until it exits as indicated at arrow 78 to passage 36 thus completing a more controlled serpentine flow path through the distributor plate.

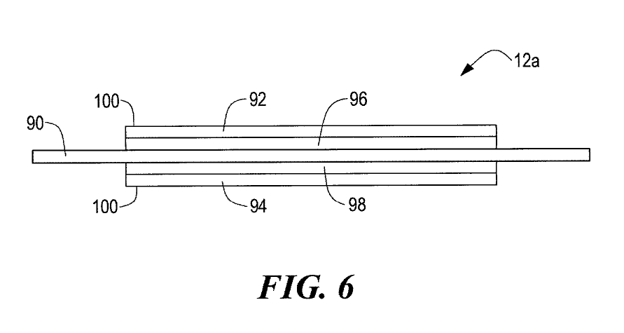

Additional passages 80, 82 may be added to frame 14′, FIG. 5 as well as the remaining parts of both the top and bottom of the separator plate, in order to conduct coolant to and remove it from the system or an individual cooling cell as previously explained. Frame 14″, FIG. 5, indicates an alternative construction where the chamfer 84 is provided around each of the four edges of the inner periphery to create a slight recess which will accommodate the electrode portion of the membrane electrode assembly while protecting the membrane itself from damage due to unbalanced pressures on its opposite sides. A typical membrane electrode assembly 12a is shown in FIG. 6 as employing a membrane 90 typically made out of Dupont Nafron 115 sandwiched between two carbon electrodes 92 and 94 with platinum catalyst layers 96, 98, in between them. The actual conversion of the hydrogen to the hydrogen ions which permeate membrane 90 occurs there at the catalyst-electrode interface. It is the edges 100 and 100′ of the electrodes 92, 94 that nest in the recess produced by chamfer 84, FIG. 5.

The chamfer around the inner edge of the frame also provides a small pinch to the membrane electrode assembly at the edge of the electrode. This pinch serves to hold the membrane electrode assembly in place and support it so that the thin membrane is effectively protected from direct pressure differences by the added strength of the electrodes.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

What is claimed is:

1. A multipart separator plate for a fuel cell comprising:
a distributor plate for directing fluid flow;
a frame surrounding said distributor plate;
an impervious separator layer; and
a seal layer between said separator layer and said distribution plate.

2. The multipart separator plate of claim 1 including an internal manifold in said frame, said separator layer and said seal layer for delivering fluid and removing fluid from said distributor plate.

3. The multipart separator plate of claim 1 in which said distributor plate directs fluid flow to the membrane electrode assembly of the fuel cell.

4. The multipart separator plate of claim 2 in which said internal manifold delivers and removes fuel gas and oxidant gas to the distributor plate.

5. The multipart separator plate of claim 2 in which distributor plate directs a coolant fluid flow and said internal manifold delivers to and removes from said distributor plate a coolant fluid.

6. The multipart separator plate of claim 1 in which said frame is chemically stable in the presence of the fuel cell fuel gas and oxidant gas.

7. The multipart separator plate of claim 1 in which said frame is thermally stable at fuel cell operating temperature.

8. The multipart separator plate of claim 1 in which said frame includes a polymer.

9. The multipart separator plate of claim 1 in which said frame includes a polycarbonate material.

10. The multipart separator plate of claim 1 in which said frame includes a polyvinyl material.

11. The multipart separator plate of claim 1 in which said frame includes a recess on its inner periphery for accommodating the periphery of the electrode of the membrane electrode assembly.

12. The multipart separator plate of claim 1 in which said frame includes stops for directing the fluid flow in said distributor plate.

13. The multipart separator plate of claim 1 in which said seal layer is electrically conductive.

14. The multipart separator plate of claim 1 in which said seal layer is thermally and chemically stable.

15. The multipart separator plate of claim 1 in which said seal layer includes a sheet of flexible graphite.

16. The multipart separator plate of claim 15 in which said seal layer includes Union Carbide Grafoil®.

17. The multipart separator plate of claim 1 in which said fuel gas includes hydrogen.

18. The multipart separator plate of claim 1 in which said fuel gas includes methanol and reformate.

19. The multipart separator plate of claim 1 in which said separator layer includes a metal.

20. The multipart separator plate of claim 1 in which said separator layer includes stainless steel.

21. The multipart separator plate of claim 1 in which said distributor plate includes porous graphite.

22. A multipart separator plate for a fuel cell comprising:
a distributor plate for presenting a fuel gas to the membrane electrode assembly of a fuel cell;
a frame surrounding said distributor plate;
an impervious separator layer; and
a seal layer between said separator layer and said distributor plate.

23. The multipart separator plate of claim 22 including an internal manifold in said frame, said separator layer and said seal layer for delivering fluid and removing fluid from said distributor plate.

24. The multipart separator plate of claim 22 in which said frame is chemically stable in the presence of the fuel cell fuel gas and oxidant gas.

25. The multipart separator plate of claim 22 in which said frame is thermally stable at fuel cell operating temperatures.

26. The multipart separator plate of claim 22 in which said frame includes a polymer.

27. The multipart separator plate of claim 22 in which said frame is a polycarbonate material.

28. The multipart separator plate of claim 22 in which said frame is a polyvinyl material.

29. The multipart separator plate of claim 22 in which said frame includes a recess on its inner periphery for accommodating the periphery of the electrode of the membrane electrode assembly.

30. The multipart separator plate of claim 22 in which said frame includes stops for directing the fluid flow in said distributor plate.

31. The multipart separator plate of claim 22 in which said seal layer is electrically conductive.

32. The multipart separator plate of claim 22 in which said seal layer is thermally and chemically stable.

33. The multipart separator plate of claim 22 in which said seal layer includes a sheet of flexible graphite.

34. The multipart separator plate of claim 22 in which said seal layer includes Union Carbide Grafoil®.

35. The multipart separator plate of claim 22 in which said fuel gas includes hydrogen.

36. The multipart separator plate of claim 22 in which said fuel gas includes methanol.

37. The multipart separator plate of claim 22 in which said separator layer includes a metal.

38. The multipart separator plate of claim 22 in which said separator layer includes stainless steel.

39. The multipart separator plate of claim 22 in which said distributor plate includes porous graphite.

40. A multipart separator plate for an electrolyzer comprising:
a distributor plate for presenting water to the membrane electrode assembly of the electrolyzer;
a frame surrounding said distributor plate;
an impervious separator layer; and
a seal layer between said separator layer and said distributor plate.
